(19) United States
(12) Patent Application Publication
(10) Pub. No.: US 2012/0078562 A1
(43) Pub. Date: Mar. 29, 2012

(54) GEOMAGNETIC SENSING DEVICE

(75) Inventors: Yukimitsu YAMADA, Niigata-ken (JP); Kisei HIROBE, Niigata-ken (JP)

(73) Assignee: ALPS ELECTRIC CO., LTD., Tokyo (JP)

(21) Appl. No.: 13/314,091

(22) Filed: Dec. 7, 2011

Related U.S. Application Data
(63) Continuation of application No. PCT/JP2010/066344, filed on Sep. 22, 2010.

(30) Foreign Application Priority Data
Sep. 26, 2009 (JP) 2009-221715

(51) Int. Cl. G06F 19/00

(52) U.S. Cl. 702/95

(57) ABSTRACT

A controller includes a calibration unit, an offset error correcting unit, an operation unit, and the like. The calibration unit obtains a reference point of an output of a magnetic sensor, and performs offset correction. The offset error correcting unit is capable of performing operation processing for both the correction of a major offset error and the correction of a minor offset error by using a radius (the magnitude of a geomagnetic vector) of a virtual circle or a virtual sphere, appropriately and easily correcting the offset error with a small amount of operation, and reducing the burden to the controller.

### CLAIM OF PRIORITY

This application is a Continuation of International Application No. PCT/JP2010/066344 filed on Sep. 22, 2010, which claims benefit of Japanese Patent Application No. 2009-221715 filed on Sep. 26, 2009. The entire contents of each application noted above are hereby incorporated by reference.

### BACKGROUND OF THE INVENTION

1. Field of the Invention

The present invention relates to a geomagnetic sensing device including a correcting unit configured to perform correction in the case where an offset error is generated after calibration.

2. Description of the Related Art

In geomagnetic sensing devices, due to the influence of magnetization and the like of peripheral components, an offset as well as a geomagnetic quantity is added to an output of a magnetic sensor. Thus, in the case of measuring the angular velocity, azimuth, etc. using a geomagnetic gyro, calibration for obtaining a reference point (the origin of a geomagnetic vector) of an output of a magnetic sensor is first performed, and offset correction is performed in accordance with the calibration (see International Publication WO2007/129653, Japanese Unexamined Patent Application Publication No. 2007-107921, and Japanese Unexamined Patent Application Publication No. 2007-139715).

However, there is a problem in that after calibration, the influence of external environment (for example, the influence of temperature or the influence of a surrounding magnetic field) causes an error in the offset mentioned above.

In the inventions described in International Publication WO2007/129653, Japanese Unexamined Patent Application Publication No. 2007-107921, and Japanese Unexamined Patent Application Publication No. 2007-139715, a unit configured to, in the case where an offset error is generated after calibration as described above, correct the offset error is not mentioned.

Furthermore, there is a problem in that, when an offset error is generated, high-accuracy measurement of angular velocity and azimuth cannot be stably achieved or sensing errors may occur.

### SUMMARY OF THE INVENTION

In order to solve the existing problems mentioned above, the present invention provides a geomagnetic sensing device including a correcting unit capable of correcting an offset error generated after calibration.

A geomagnetic sensing device according to an aspect of the present invention includes a magnetic sensor having two or more axes; and a controller including a calibration unit configured to obtain a reference point of an output of the magnetic sensor and a correcting unit configured to correct an offset error. The correcting unit includes an extraction step of extracting a plurality of output coordinate points that are deviated from an outer edge of a virtual circle or an outer edge of a virtual sphere having a radius R defined by the magnitude of a geomagnetic vector centered at the reference point and that are located at coordinate positions different from each other, a first step of marking a coordinate position that is on a virtual straight line extending from a first output coordinate point and passing through the reference point and that is moved from the first output coordinate point toward the reference point by a distance corresponding to the radius R, a second step of newly marking a coordinate position that is moved on a virtual straight line extending from a second output coordinate point and passing through the marked position obtained in the first step from the second output coordinate point toward the marked position by the distance corresponding to the radius R, and a third step of repeatedly performing the second step for sequentially updating the most recently set marked position to a new marked position alternately between the individual output coordinate points in order and setting a convergent point of the marks as a new reference point of an output of the magnetic sensor.

Accordingly, even in the case where an offset error is generated after calibration, the offset error can be appropriately corrected. In particular, in the aspect of the present invention mentioned above, a minor offset error can be appropriately coped with. Furthermore, operation processing can be performed using the radius R (the magnitude of a geomagnetic vector) of the virtual circle or the virtual sphere, and the offset error can be corrected appropriately and easily with a small amount of operation. Thus, the burden to the controller can be reduced.

Preferably, the magnetic sensor has three axes, and in the extraction step, at least three output coordinate points that are deviated from the outer edge of the virtual sphere having the radius R centered at the reference point and that are located at coordinate positions different from each other are extracted, or the magnetic sensor has two axes, and in the extraction step, at least two output coordinate points that are deviated from the outer edge of the virtual circle having the radius R centered at the reference point and that are located at coordinate positions different from each other are extracted, and the first to third steps are performed.

In addition, preferably, in a case where an output coordinate point is deviated further outward than the outer edge of the virtual circle or the virtual sphere having the radius R centered at the reference point and is located at a coordinate position that is distant from the reference point by a specific number of times or more the length of the radius R, the correcting unit includes, prior to the extraction step, a first correction step of drawing a virtual straight line between the coordinate point and the reference point and setting a coordinate position that is moved from the output coordinate point toward the reference point by the distance corresponding to the radius R as a new reference point.

In the case where a major offset error is generated, the offset error is dynamically corrected by first performing the first correction step, without performing the extraction step and the first to third steps. In the dynamic correction of an offset error, operation processing can be performed using the radius R (the magnitude of a geomagnetic vector) of a virtual circle or a virtual sphere, and the offset error can be corrected easily with a small amount of operation. Thus, the burden to the controller can be reduced.

According to the present invention, even in the case where an offset error is generated after calibration, the offset error can be appropriately corrected.

### BRIEF DESCRIPTION OF THE DRAWINGS

FIG. 1 is a circuit block diagram of a geomagnetic sensing device according to an embodiment of the present invention;

FIG. 2 is an explanatory diagram of an X-axis magnetic sensor, a Y-axis magnetic sensor, and a Z-axis magnetic sensor provided in a sensor portion;

FIG. 3 is a schematic diagram of a reference point of an output obtained by a calibration process and a virtual sphere with a radius R centered at the reference point;

FIG. 4 is a schematic diagram for explaining a step for performing a first offset error correction (dynamic correction);

FIG. 5 is a schematic diagram for explaining a step for performing a second offset error correction;

FIG. 6 is a flowchart for explaining an operation by an offset error correcting unit of a controller; and

FIG. 7 is a flowchart of the step for performing the second offset error correction.

### DESCRIPTION OF THE PREFERRED EMBODIMENTS

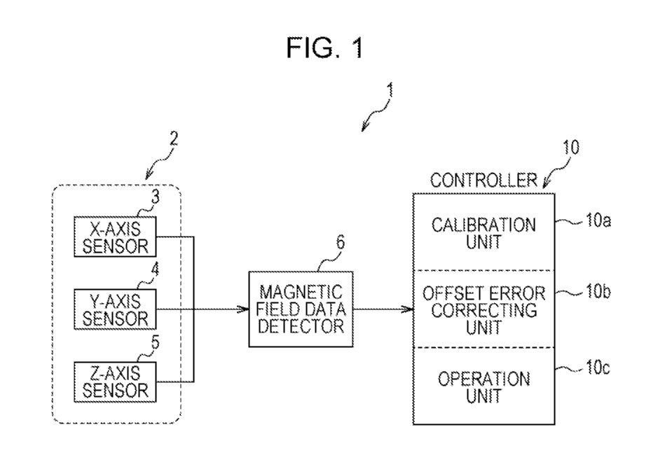

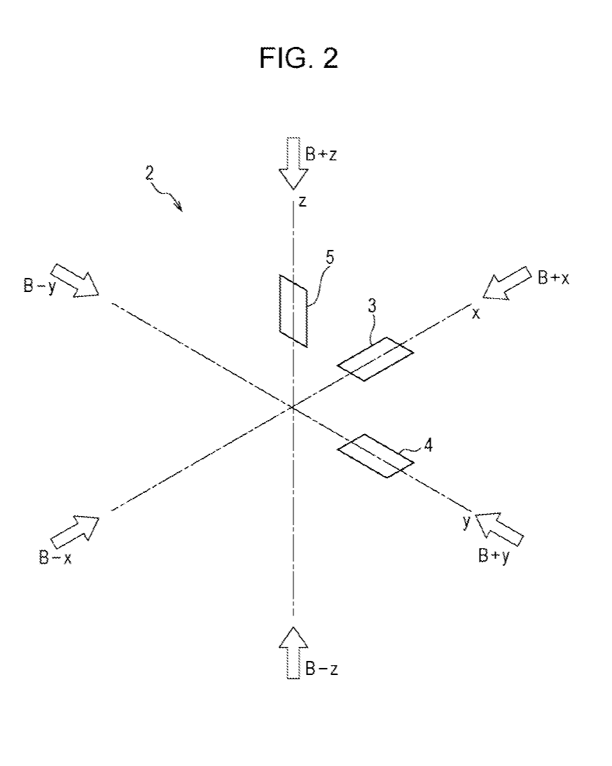

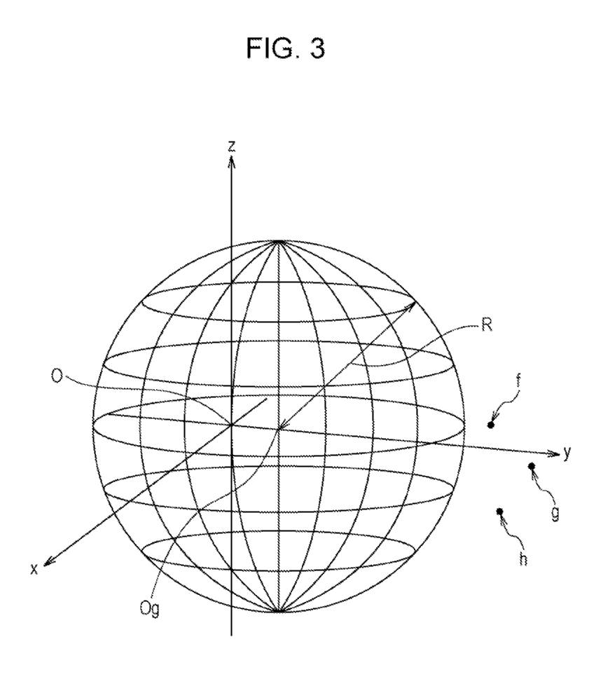

FIG. 1 is a circuit block diagram of a geomagnetic sensing device according to an embodiment of the present invention. FIG. 2 is an explanatory diagram of an X-axis magnetic sensor, a Y-axis magnetic sensor, and a Z-axis magnetic sensor provided in a sensor portion. FIG. 3 is a schematic diagram of a reference point Og of an output obtained by a calibration process and a virtual sphere with a radius R centered at the reference point Og.

A magnetic sensor 2 provided in a geomagnetic sensing device 1 according to an embodiment of the present invention illustrated in FIG. 1 has a configuration supporting three axes. That is, the magnetic sensor 2 is configured to include an X-axis magnetic sensor 3, a Y-axis magnetic sensor 4, and a Z-axis magnetic sensor 5.

In the embodiment illustrated in FIGS. 1 and 2, the X-axis magnetic sensor 3, the Y-axis magnetic sensor 4, and the Z-axis magnetic sensor 5 are each include a giant magneto-resistance (GMR) element, an anisotropic magneto-resistance (AMR) element, a Hall element, etc.

The X-axis magnetic sensor 3 detects a component Bx, which directs in a geomagnetic reference X-direction, and is capable of detecting a magnetic field component B+x, which is in the positive direction in the reference X-direction, and a magnetic field component B−x, which is in the negative direction in the reference X-direction.

The Y-axis magnetic sensor 4 detects a component By, which directs in a geomagnetic reference Y-direction, and is capable of detecting a magnetic field component B+y, which is in the positive direction in the reference Y-direction, and a magnetic field component B−y, which is in the negative direction in the reference Y-direction.

The Z-axis magnetic sensor 5 detects a component Bz, which directs in a geomagnetic reference Y-direction, and is capable of detecting a magnetic field component B+z, which is in the positive direction in the reference Z-direction, and a magnetic field component B−z, which is in the negative direction in the reference Z-direction.

A magnetic field data detector 6 illustrated in FIG. 1 includes an electric circuit in which the sensors 3, 4, and 5 are connected in series with fixed resistors. The midpoint voltage between the X-axis magnetic sensor 3 and the fixed resistor, the midpoint voltage between the Y-axis magnetic sensor 4 and the fixed resistor, and the midpoint voltage between the Z-axis magnetic sensor 5 and the fixed resistor can be extracted as a detection output in the X-axis, a detection output in the Y-axis, and a detection output in the Z-axis, respectively.

As illustrated in FIG. 1, the detection outputs in the X-axis, Y-axis, and Z-axis detected by the magnetic field data detector 6 are supplied to a controller 10. The controller 10 is configured to include a calibration unit 10a, an offset error correcting unit 10b, an operation unit 10c, and the like. The operation unit 10c includes an angular velocity operation part, an angular acceleration operation part, an azimuth operation part, and the like. The calibration unit 10a, the offset error correcting unit 10b, and the operation unit 10c are each implemented by programmed software.

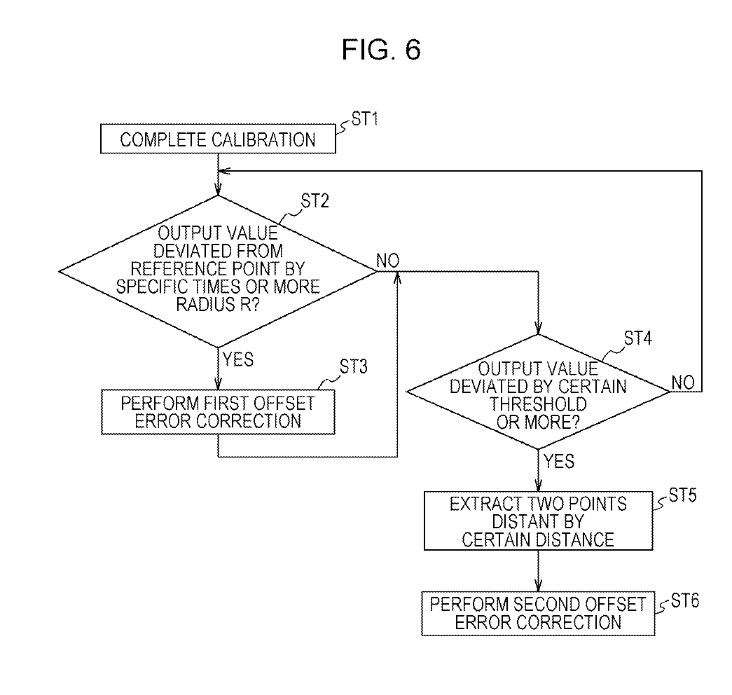

The operation of the controller 10 will now be explained. In this embodiment, as illustrated in FIG. 6, the calibration unit 10a performs a calibration process (offset correction) in step ST1.

Namely, in the geomagnetic sensing device 1, due to the influence of magnetization and the like of peripheral components, an offset as well as a geomagnetic quantity is added to an output of the magnetic sensor. Thus, it is necessary that calibration for obtaining a reference point (the origin of a geomagnetic vector) of an output of the magnetic sensor should be first performed and offset correction should be performed in accordance with the calibration.

For example, the geomagnetic sensing device 1 according to this embodiment is moved at random to detect a large number of coordinate points of outputs of the magnetic sensor 2 in a three-dimensional space (here, an output means an output obtained by the magnetic field data detector 6, and the same applies to the following cases), and the calibration unit 10a calculates the center of a virtual sphere, which is obtained from these coordinate points. Then, as illustrated in FIG. 3, the center of the virtual sphere is set as a reference point (the origin of a geomagnetic vector) of an output. As illustrated in FIG. 3, the virtual sphere is a spherical body with a radius R centered at the reference point Og. The radius R represents the magnitude of a geomagnetic vector. As illustrated in FIG. 3, the reference point Og is located at a position that is deviated from the intersection O of the reference X-direction, the reference Y-direction, and the reference Z-direction. The amount of difference between the reference point Og and the intersection O is defined as an offset.

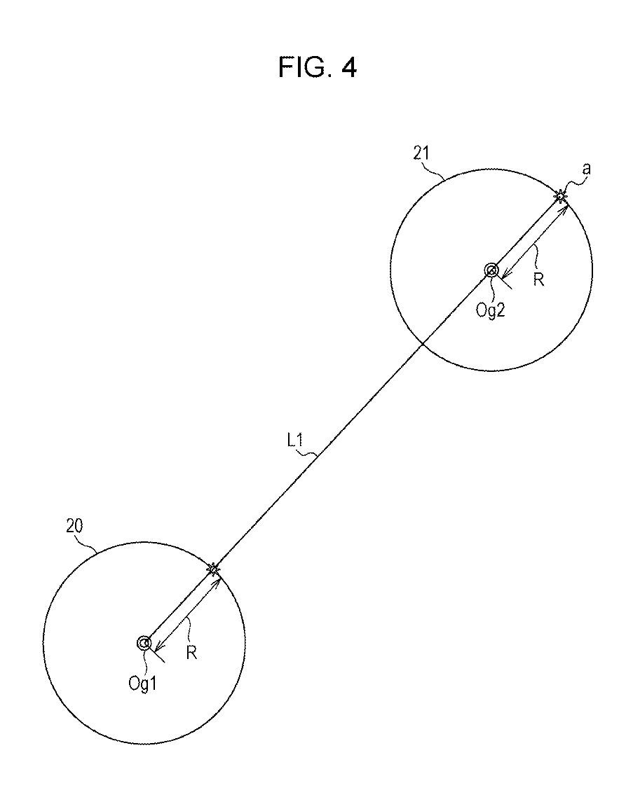

In this embodiment, the magnetic sensor 2 composed of the three axes in FIG. 1 is capable of obtaining the virtual sphere centered at the reference point Og of an output illustrated in FIG. 3 by calibration. However, in the case where, for example, a magnetic sensor is composed of two axes, the X-axis magnetic sensor 3 and the Y-axis magnetic sensor 4, a virtual circle 20 with a radius R centered at a reference point Og1 of an output of the magnetic sensor can be obtained on the X−y coordinate plane by calibration, as illustrated in FIG. 4. Hereinafter, correction of an offset error will be explained. For an easier explanation, the explanation will be given in a two-dimensional manner.

After step ST1 of the calibration process illustrated in FIG. 6 is completed, an error may be generated in the offset due to the influence of temperature or the influence of a surrounding magnetic field. In such a case, in this embodiment, the offset error can be corrected by the offset error correcting unit 10b.

First, in step ST2 in FIG. 6, if, as illustrated in FIG. 4, the currently obtained coordinate point a of an output of the magnetic sensor is located at a coordinate position that is deviated further outward than the outer edge of the virtual circle 20 and the coordinate point a is distant from the reference point Og1 by a specific number of times or more (more specifically, twice or more, and for example, defined as three times) the length of the radius R, the process proceeds to the next step for performing a first offset error correction (first correction step ST3).

In the first correction step ST3, as illustrated in FIG. 4, a virtual straight line L1 is drawn between the output coordinate point a and the reference point Og1, and the coordinate position that is moved from the coordinate point a toward the reference point Og1 by the distance corresponding to the radius R is set as a new reference point Og2.

In the first correction step ST3, for example, in the case where, after calibration is completed, the geomagnetic sensing device 1 is placed under the circumstances having a strong magnetic field and a major offset error is generated, the offset error can be dynamically corrected in the first correction step ST3.

As illustrated in FIG. 6, in the case where the obtained output coordinate point is not distant from the reference point Og1 by a specific number of times or more the length of the radius R, the process does not proceed to the first correction step ST3. That is, in the case where a major offset error is not generated, although the process does not proceed to the first correction step ST3, a minor offset error may be generated. In addition, even if an offset error is dynamically corrected as illustrated in FIG. 4, a minor offset error may be generated when viewed from the new reference point Og2. Although depending on the use or a required accuracy, in the case where it is determined in step ST4 that this minor offset error is not too small to be neglected, the process proceeds to extraction step ST5 and a second offset error correction (second correction step ST6).

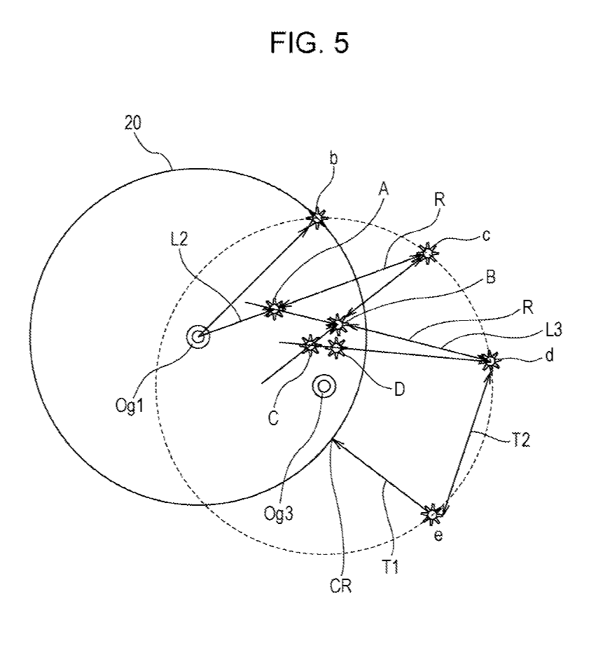

In step ST4 illustrated in FIG. 6, the offset error correcting unit 10b determines whether or not an output value of the magnetic sensor is deviated by a certain threshold or more. As illustrated in FIG. 5, among a plurality of output values (output coordinate points) b, c, d, and e obtained from the magnetic sensor, the output coordinate points c, d, and e are located at coordinate positions that are deviated further outward than the outer edge of the virtual circle 20 (the virtual circle 21 in the case where change to the reference point Og2 illustrated in FIG. 4 has been made in the first correction step ST3) and the coordinate positions differ from each other.

Among these output coordinate points, the output coordinate point e is deviated from an intersection CR, at which a line drawn between the output coordinate point e and the reference point Og1 and the virtual circle 20 intersect, by an error amount T1 or more. This state is defined as, for example, the state “being deviated by a certain threshold or more” described above.

By setting the error amount T1 to be smaller, a much smaller offset error can be corrected. However, the error amount T1 can be set in a desirable manner while taking into consideration the use, a required accuracy, the burden to the controller 10, and the like.

As illustrated in FIG. 6, when the determination in step ST4 is “Yes”, the process proceeds to the extraction step ST5, in which two output coordinate points that are distant by a certain distance are extracted. In step ST5, at least two points are extracted. This is for the case where an offset error is corrected on a two-dimensional coordinate, as illustrated in FIG. 5. For the case where an offset error is corrected in a three-dimensional space as illustrated in FIG. 3, it is necessary to extract at least three points (coordinate points f, g, and h in FIG. 3).

Here, the output coordinate points c and d, which are distant from the output coordinate point e by a distance T2 or more, are certified as the “two points distant by a certain distance” described above. The output coordinate point c is defined as a first output coordinate point c and the output coordinate point d is defined as a second output coordinate point d. Then, the process proceeds to the second correction step ST6 illustrated in FIG. 6. Here, the first output coordinate point c and the second output coordinate point d are located at coordinate positions different from each other, and the output coordinate points c and d are distant from each other by a predetermined distance or more.

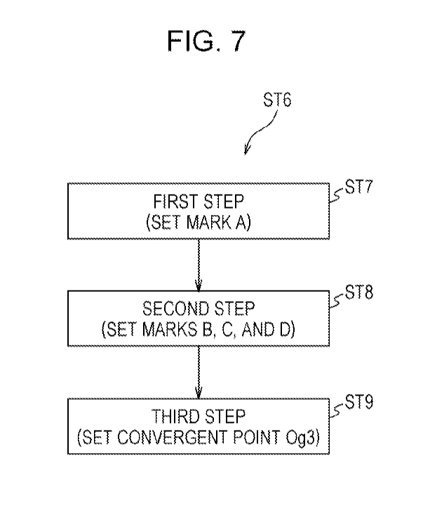

Next, the second correction step ST6 will be explained in detail with reference to FIGS. 5 and 7. In the second correction step ST6, first, as first step ST7, a virtual straight line L2 extending from the first output coordinate point c and passing through the reference point Og1 is drawn on the coordinate plane. Then, a coordinate position that is on the virtual straight line L2 and that is moved from the first output coordinate point c toward the reference point Og1 by the distance corresponding to the radius R is marked (set a marked position A).

Then, as second step ST8 in the second correction step ST6, a virtual straight line L3 extending from the second output coordinate point d and passing through the marked position A is drawn on the coordinate plane. Then, a coordinate position that is on the virtual straight line L3 and that is moved from the second output coordinate point d toward the marked position A by the distance corresponding to the radius R is marked (set a marked position B).

The second step ST8 mentioned above is repeatedly performed alternately between the first output coordinate point c and the second output coordinate point d, so that the most recently set marked position is sequentially updated to a new marked position. That is, the next virtual straight line extending from the first output coordinate point c and passing through the marked position B is drawn on the coordinate plane, and a coordinate position that is on the virtual straight line and that is moved from the first output coordinate point c toward the marked position B by the distance corresponding to the radius R is marked (set a marked position C). Subsequently, the next virtual straight line extending from the second output coordinate point d and passing through the marked position C is drawn on the coordinate plane, and a coordinate position that is on the virtual straight line and that is moved from the second output coordinate point d toward the marked position C by the distance corresponding to the radius R is marked (set a marked position D).

By repeatedly performing the second step ST8 mentioned above alternately between the first output coordinate point c and the second output coordinate point d, a marked position finally reaches a convergent point Og3. As third step ST9, the convergent point Og3 is set as a new reference point of an output of the magnetic sensor. The distance between the convergent point (reference point) Og3 and the first output coordinate point c and the distance between the convergent point (reference point) Og3 and the second output coordinate point d are each equal to the radius R.

In the third step ST9, when a marked position falls within a specific range, it may be determined that convergence has been achieved and defining of a convergent point may be done. For example, when the distance between the first output coordinate point c and a marked position and the distance between the second output coordinate point d and the marked position each fall within a range between the radius R and the radius R+α, the marked position can be defined as a convergent point.

By performing the second correction step ST6 illustrated in FIGS. 5 and 7, a minor offset error can be corrected highly accurately.

As illustrated in FIG. 3, in the case of a three-dimensional space, at least three different output coordinate points f, g, and h are required for performing the second correction step ST6. After the first step ST7 of the second correction step ST6 illustrated in FIG. 7 is performed between the first output coordinate point f and the reference point Og to set a marked position A, the second step ST8 for sequentially updating the most recently marked position to a new marked position is repeatedly performed for the second output coordinate point g→the third output coordinate point h→the first output coordinate point f→the second output coordinate point g→the third output coordinate point h→ . . . in that order, so that a convergent point can be derived in the three-dimensional space.

In this embodiment, operation processing for both the correction of a major offset error and the correction of a minor offset error can be performed using the radius R (the magnitude of a geomagnetic vector) of a virtual circle or a virtual sphere obtained by calibration, and the offset error can be corrected appropriately and easily with a small amount of operation. Thus, the burden to the controller 10 can be reduced.

In this embodiment, in the case of a larger offset error, the first correction step ST2 explained with reference to FIG. 5 is performed, so that the reference point Og2 is dynamically changed. After that, according to need, that is, in the case where the determination in step ST4 illustrated in FIG. 6 is “Yes”, the extraction step ST5 for extracting a plurality of output coordinate points and the second correction step ST6 are performed.

The geomagnetic sensing device 1 according to this embodiment may be used as a geomagnetic gyro. In this embodiment, after calibration, an offset error can be appropriately corrected, and the accuracy in measuring the angular velocity can be improved. Alternatively, the geomagnetic sensing device 1 according to this embodiment may be used as an azimuth indicator, and the azimuth accuracy can be improved.

The geomagnetic sensing device 1 according to the present invention may be used for a portable device such as a cellular phone, a game machine, a robot, and the like.

What is claimed is:

1. A geomagnetic sensing device comprising:
a magnetic sensor having two or more axes; and
a controller including calibration means for obtaining a reference point of an output of the magnetic sensor and correcting means for correcting an offset error,
wherein the correcting means includes an extraction step of extracting a plurality of output coordinate points that are deviated from an outer edge of a virtual circle or an outer edge of a virtual sphere having a radius R defined by the magnitude of a geomagnetic vector centered at the reference point and that are located at coordinate positions different from each other, a first step of marking a coordinate position that is on a virtual straight line extending from a first output coordinate point and passing through the reference point and that is moved from the first output coordinate point toward the reference point by a distance corresponding to the radius R, a second step of newly marking a coordinate position that is moved on a virtual straight line extending from a second output coordinate point and passing through the marked position obtained in the first step from the second output coordinate point toward the marked position by the distance corresponding to the radius R, and a third step of repeatedly performing the second step for sequentially updating the most recently set marked position to a new marked position alternately between the individual output coordinate points in order and setting a convergent point of the marks as a new reference point of an output of the magnetic sensor.

2. The geomagnetic sensing device according to claim 1, wherein the magnetic sensor has three axes, in the extraction step, at least three output coordinate points that are deviated from the outer edge of the virtual sphere having the radius R centered at the reference point and that are located at coordinate positions different from each other are extracted, and the first to third steps are performed.

3. The geomagnetic sensing device according to claim 1, wherein the magnetic sensor has two axes, in the extraction step, at least two output coordinate points that are deviated from the outer edge of the virtual circle having the radius R centered at the reference point and that are located at coordinate positions different from each other are extracted, and the first to third steps are performed.

4. The geomagnetic sensing device according to claim 1, wherein in a case where an output coordinate point is deviated further outward than the outer edge of the virtual circle or the virtual sphere having the radius R centered at the reference point and is located at a coordinate position that is distant from the reference point by a specific number of times or more the length of the radius R, the correcting means includes, prior to the extraction step, a first correction step of drawing a virtual straight line between the coordinate point and the reference point and setting a coordinate position that is moved from the output coordinate point toward the reference point by the distance corresponding to the radius R as a new reference point.
